(19) United States
(12) Patent Application Publication
(10) Pub. No.: US 2005/0117218 A1
(43) Pub. Date: Jun. 2, 2005

(54) Switchable latching-type faraday rotator

(75) Inventors: Qiangsheng Xiang, Newark, CA (US); Gang Huang, Richmond, VA (US); Xiangzhi Lin, Beijing (CN)

Correspondence Address: Qiangsheng Xiang, 37037 Magnolia St. #226, Newark, CA, 94560, US

(73) Assignees: Primanex Corporation, Fremont, CA (US); Primanex (China) Corporation, Zhaoyuan (CN)

(21) Appl. No.: 10/724,661

(22) Filed: Dec. 1, 2003

(51) Int. Cl. H01F 1/00

(52) U.S. Cl. 359/484; 335/219

(57) ABSTRACT

The present invention relates to the. use of optimized magnet design, magnetic circuit design and wire coil design to improve latching reliability and reduce driving current for the switchable Faraday rotator devices. The geometrical parameters of semi-hard magnet are optimized to produce maximal magnetic field at the location of magneto-optic crystal and hence improve latching reliability and reduce driving current. The wire coil is optimized in coil length, wire gauge, and number of turns to produce most efficient energy transfer and hence reduce driving current and driving voltage. To reduce magnetic energy loss, soft magnetic material is included to form a magnetic conductive close loop and further reduces driving current requirements.

### BACKGROUND

1. Technical Field

The present invention relates to the general field of switchable latching Faraday rotators and, more particularly, relates to enhancing the switching and latching reliability, and reducing driving current and voltage.

2. Description of Related Art

Faraday rotation is a magneto-optic effect in which the plane of polarization of polarized light is caused to rotate by passage through a magneto-optic material to which is applied an external magnetic field. The combination of magneto-optic material and a means for application of an external magnetic field is denoted as a “Faraday rotator”.

The rotation angle, θ, denotes the angle through which the plane of polarization is rotated by the magneto-optic material. Typically, θ is approximately proportional to the intensity of the magnetic field applied to the magneto-optic material in the direction of propagation of the light through the material as in Eq. 1.
θ=K−H_{∥} Eq. 1
in which:
θ=the rotation angle
H_{∥}=the magnitude of the magnetic field applied to the magneto-optic crystal in the direction of light propagation.
K=a constant dependent on the particular magneto-optic material and the thickness of the material.

According to their applications, Faraday rotators can be classified as three major categories: fixed rotators, switchable rotators and variable rotators. Fixed rotators use fixed magnetic field or permanently magnetized magneto-optic materials, so that the rotation angle is fixed and cannot be controlled or switched. Switchable rotators, however, use switchable magnetic field so that the rotation angle is switchable between two possible values. Variable rotators, instead of switch between two possible states, use variable magnetic field to generate variable rotation angle.

Faraday rotators have been employed as components or subsystems in various optical devices. For example, fixed rotators are widely used in isolators and circulators, variable rotators can be used in variable optical attenuators, and switchable rotators can be used in optical switches. Compared with opto-mechanic technologies, the switchable or variable magneto-optical devices have no moving-parts and hence have incomparable reliability. The importance of such devices will increase with the steady growth of the optical fiber networks.

The fixed rotators use permanent magnet to generate fixed magnetic field, or use permanently magnetized magneto-optical material to generate fixed rotation angle, so that electrical parts are not necessary for the fixed Farady rotator. The switchable rotators and variable rotators, on the contrary, need electrical circuit to convert electrical control signal into switchable or variable magnetic field. The switchable rotators and variable rotators can be further divided into two categories: latching type and non-latching type. “Latching” denotes the ability to retain the rotation angle after the applied electrical control signal is removed. In most situations, latching is preferred for Faraday rotators due to the electrical power consumption consideration.

Usually a switchable latching type Faraday rotator at least includes the following parts: magneto-optic material, wire coil, and semi-hard magnetic material. The wire coil is used to convert the electrical energy into magnetic energy. The semi-hard magnetic material is used to provide a sustainable magnetic field for the magneto-optic crystal after the electrical current is removed. The semi-hard magnetic material is a category of magnetic material which is very similar to hard (or permanent) magnetic material, only that semi-hard materials has relatively lower coercive force (Hc). “Coercive force” is the demagnetizing force, measured in Oesteds, necessary to reduce observed magnetic induction (B) to zero after the magnet has previously been brought to saturation. “Saturation” is the condition under which all elementary magnetic moments have been oriented in one direction. According to the Magnetic Materials Products Association Standard No. 0100-00: a permanent magnetic material, also designated as a magnetically hard material, has a coercive force generally greater than 120 Oersted. A semi-hard magnetic material generally has a coercive force less than 120 Oersted and greater than 10 Oersted. The semi-hard magnetic material is very critical to the performance of switchable latching type Faraday rotators. The driving current of the latching type Faraday rotator is directly related to the coercive force of the semi-hard material. Lower coercive force means lower magnetic field is needed for the semi-hard material to reverse its status and hence lower current is needed to produce the corresponding magnetic field. Obviously the driving current is also related to the structure of the wire coil and the magnetic circuit that directly affects the efficiency of energy conversion. The latching reliability is connected to the properties of the magneto-optic material and the magnetic field strength at the location of magneto-optic material. Stronger magnetic field at the location of the magnetic-optical material results in more reliable latching.

Besides the latching capability, the switchable or variable rotators should also meet the following requirements to be widely used as a practical commercial optical device: 1. Low control voltage and control current. For example, the switchable Faraday rotators used in telecommunication applications usually require the control voltage be lower than 5 Volts, and the control current be lower than 200 mA and the lower the better. 2. Temperature-proof latching reliability. It is a common requirement that the status should be firmly latched when temperature varies from −40° C. to 85° C. 3. Small physical profile. In the application of telecommunication, the optical devices used together with the Faraday rotators are usually in the scale of a few millimeters, which implies that Faraday rotators used in this field should be in the scale of a few millimeters too.

However, prior art switchable Faraday rotators cannot meet these requirements listed above. Most of the conventional Faraday rotators are not switchable, or switchable but not latchable[U.S. Pat. No. 5,535,046]. Some Faraday rotators do switch and latch, but require too much driving current (usually large than 1 A) to prevent them from being used in practical optical systems. The dual difficulties of lack of stable latching capability and the need for high switching current has precluded magneto-optic (Faraday rotator) switches from capturing a major share of the applications for optical switches.

FIG. 1 depicts a conventional prior art switchable Faraday rotator with latching capability, which is disclosed in the U.S. Pat. No. 4,609,257 to Shirasaki. The device of FIG. 1 includes a magneto-optic material 1, electromagnet including a current-carrying coil 3 generating a magnetic field, and a semi-hard magnetic material 2. In the operation of the Faraday rotator of FIG. 1, the electromagnet applies a magnetic field, H, to magneto-optic material, 1. Current flowing through coil 3 from left to right in FIG. 1 generates magnetic field H in the direction shown by the arrow H. To change the rotation direction of the Faraday rotator, the magnetic field is reversed by reversing the current in coil 3 causing a change in the direction of magnetization in the semi-hard material, 2.

However, the Faraday rotator depicted in FIG. 1 has major drawbacks, including the following: First, at the location of the magneto-optic material, the major component of the magnetic field is perpendicular to the light traveling path, hence most of the magnetic energy cannot contribute to Faraday rotation. Second, a significant portion of the magnetic energy is consumed and wasted by the long arms of the electromagnet. Third, since most of the magnetic field is just wasted, it requires very large driving current to magnetize and latch the magneto-optic material. Fourth, this design has large asymmetrical physical profile and it is unsuitable to use it into the compact optical devices.

FIG. 2 shows another prior switchable latching type Faraday rotator which is disclosed in U.S. Pat. No. 5,048,937. This device consists of (a) magneto-optic material 4, (b) a wire coil 5 encircling the magneto-optic material for the purpose of changing the magnetization state of the Faraday rotator, and (c) a semi-hard hollow yoke 6 surrounding the assembly of coil and magneto-optic material. Again, the coil 5 does not encircling the hollow yoke 6 pursuant to this disclosure.

Since the hollow yoke is located outside of the coil, the magnetic field at the position of the hollow yoke (i.e., position D) generated by the coil is much smaller than the magnetic field at position C within the coil. Thus, this device has the disadvantage of not effectively magnetizing the hollow yoke, hence needs very large current to achieve latching functionality. According to the data given by the patent disclosure, the minimum current need to achieve latching is about 3 Amps.

FIG. 3 and FIG. 4 show two embodiments of a prior art Faraday rotator which is disclosed in US patent (M11838, 785653). Both structures includes: magneto-optic crystal (101), wire coil (102), coil holder (103), semi-hard magnets (104). FIG. 4 further introduced soft magnetic materials (105) so that 105, 104 and 101 can form a magnetic loop and hence reduce the magnetic loss. According to the patent disclosure, this structure can reduce the driving current to 100 mA˜200 mA. Although there is substantial improvement in driving current compared with FIG. 1 and FIG. 2 (needs 3 Amps driving current), the driving current (large than 100 mA) is still too high for optical communication applications. Actually there are some essential problems in FIG. 3 and FIG. 4 to prevent them to further reduce the driving current:
1. The geometrical parameters of the semi-hard magnets are not optimized so that the magnetic field at the location of magneto-optic material is not maximal. Most of the magnetic energy is just wasted.
2. The air gap between magneto-optic material (101) and the semi-hard magnets (104) will further introduce magnetic energy loss.
3. The coil holder (103) increases the inner diameter of the wire coil (102), and decreases the efficiency of electrical to magnetic energy conversion.
   All these problems listed above for FIGS. 3 and 4 not only affect the driving current, but also affect the latching reliability. Since the magnetic field at the location of magneto-optic crystal is not strong enough, the status of the magneto-optic crystal maybe unstable at high temperature (85° C.).

### SUMMARY

The objective of the present invention relates to providing a switchable latching-type Faraday rotator having low electrical power consumption, small physical profile, as well as reliable latching capability.

The switchable latching Faraday rotator according to the present invention comprises: (1) a magneto-optic crystal, (2) semi-hard magnets which are adjacent to the magneto-optic crystal (3) wire coil encompassing the magneto-optic crystal and semi-hard magnets (4) soft magnetic tubes and adaptors which form a magnetic conductive loop.

The present invention optimizes the semi-hard magnets design so that the semi-hard magnets can generate maximum magnetic field at the location of magneto-optic crystal. This optimized design lows driving current and voltage, improves latching reliability and reduces physical profile of the Faraday rotator.

The present invention also optimizes the wire coil design so that both low driving voltage and low driving current requirements can be meet at the same time.

After all these efforts, the present invention can bring the driving voltage down to 4V and driving current down to 55 mA. The present invention also improves latching reliability of the Faraday rotators. The Faraday rotators made with present invention can latch in their original status for a few weeks in the 85° C. oven.

### DESCRIPTION OF THE DRAWINGS

The drawings herein are not to scale.

FIG. 1: A schematic depiction of one example of a prior art Faraday rotator.

FIG. 2: A schematic depiction of one example of a prior art Faraday rotator.

FIG. 3: A schematic depiction of one example of a prior art Faraday rotator.

FIG. 4: A schematic depiction of one example of a prior art Faraday rotator.

FIG. 5: hysteresis curve of magneto-optic material

FIG. 6. hysteresis curve of semi-hard material

FIG. 7. A typical assembly of semi-hard magnets and magneto-optic crystal

FIG. 8: semi-hard magnets

FIG. 9: Magnetic field vs. the length of semi-hard magnet

FIG. 10: An embodiment of present invention

FIG. 11: magnetic field distribution for present invention (FIG. 10)

FIG. 12: Magnetic field distribution for a prior art as described in FIG. 3.

### DETAILED DESCRIPTION

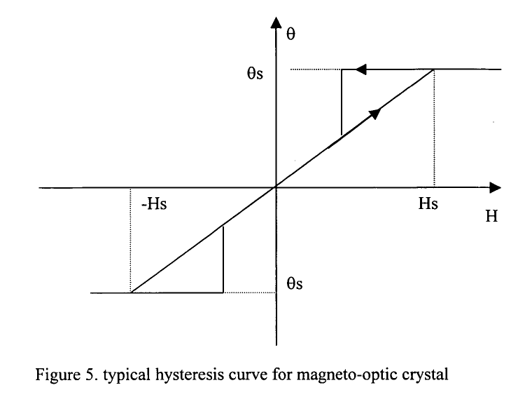

Magneto-optic material is the core material for the Faraday rotators. FIG. 5 depicts a typical magnetizing and demagnetizing curve of magneto-optic material. H is the external magnetic field which is applied to parallel to the light traveling path. Hs is usually called as “saturation magnetic field” or simply as “saturation point”, where the magneto-optic crystal is saturated.

To use the magneto-optic crystal in a switchable Faraday rotator, it is necessary to drive the magneto-optic crystal beyond two saturation points, Hs and −Hs. To be a latching type Faraday rotator, it is also necessary to provide sustainable magnetic field which is strong enough to drive the magneto-optic crystal into saturation region and reliably hold the saturation status. The semi-hard magnetic material is an ideal candidate for this application. The semi-hard magnetic material has very low coercive force (Hc<120 Oersted) so that it can be easily magnetized or reverse magnetized by a wire coil. On the other hand, the semi-hard magnetic material has large residual induction (Br>5000 Gauss) so that it can produce strong magnetic field in its surrounding region after the external magnetic field is removed.

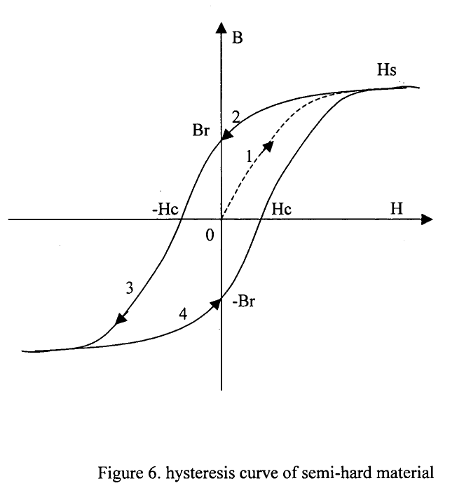

FIG. 6 shows the hysteresis curve of the semi-hard magnetic material. Trace 1 shows how the semi-hard magnet core is magnetized while the external magnetic field increases from zero to saturation magnetic field (Hs). Trace 2 shows that after external magnetic field is removed a residual magnetic induction (Br) remains inside the semi-hard material. However, the actual magnetic induction which remains in a magnet is dependent on the geometry of magnetic circuit and the history of the magnetization. It could be less than the residual induction (Br) if the magnet is not previously saturated or there is air gap in the magnetic circuit. To ensure latching reliability of the Faraday rotator, the semi-hard magnetic material should be magnetized into saturation state and a magnetic conductive close loop should be built up so that maximal magnetic flux could be generated.

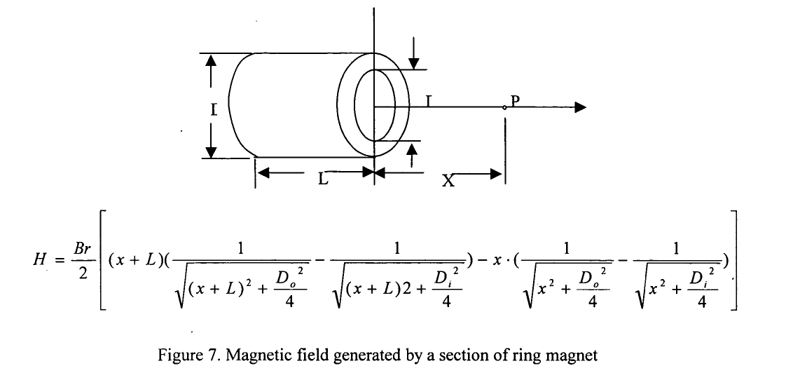

The magnetic field at the location of magneto-optical crystal generated by semi-hard magnet is dependent on the geometrical shape of the semi-hard magnet and the position of magneto-optic crystal. FIG. 7 shows the magnetic filed generated by a section of circular magnet ring. FIG. 7 shows that the magnetic field generated by a magnet is dependent on the following factors: 1. residual induction of the magnet (Br), 2. the geometrical shape of the magnet 3. the location of the testing point. FIG. 7 indicates that an optimized magnet length exists to produce maximum magnetic field at certain point.

One major objective of present invention is to provide a switchable Faraday rotator with highly reliable latching performance. This is realized by introducing very high magnetic field at the magneto-optic material position. In detail, this objective is implemented by: 1. choosing optimized semi-hard and magneto-optic material, 2. choosing optimized geometrical structure for the semi-hard magnet and magnetic circuit. 3. mounting the magneto-optic crystal into an optimized position.

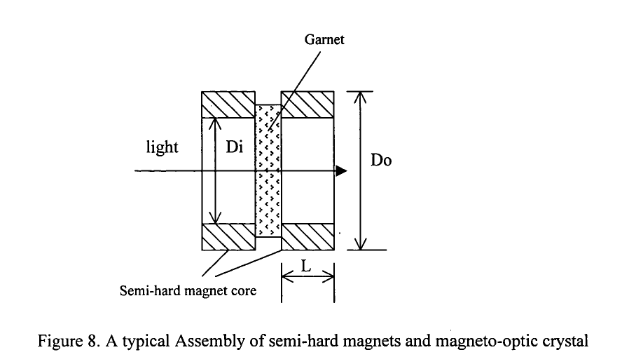

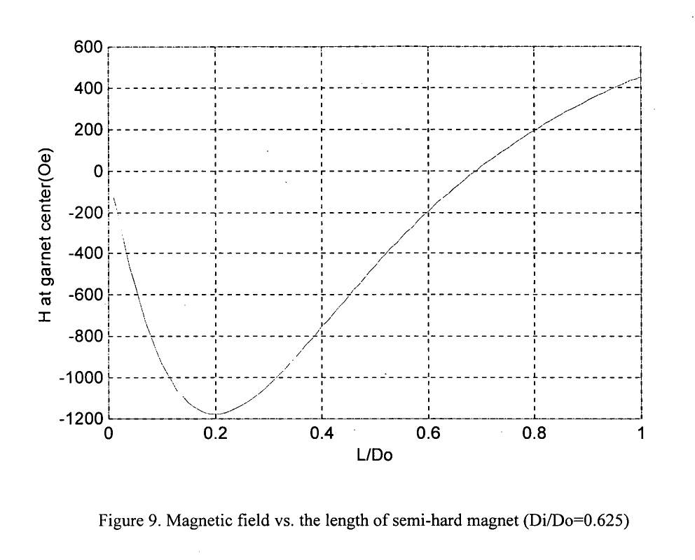

FIG. 8 shows an embodiment of the assembly of semi-hard magnet and magneto-optical material for present invention. The garnet, which is approximately 0.5 mm in thickness, is sandwiched by two identical semi-hard circular magnet rings. In this embodiment, an optimized ring length exists to produce maximized magnetic field at the center of the garnet. FIG. 9 shows the numerical relationship between the magnetic field at the center of garnet and the length of magnet core. In this embodiment, Di/Do=0.625, and the optimized ring length is 0.2*Do, where Di is the inner diameter and Do is the outer diameter of the magnet ring. The residual induction of the semi-hard magnet is about 13,000 Gauss, and a maximum magnetic field of 1150 Oersted can be generated at the location of magneto-optic crystal.

Another major objective of the present invention is to achieve switching and latching function with low electrical power consumption, including low driving voltage and low driving current. To achieve this objective, the wire coil design is also need to be optimized so that maximal energy conversion efficiency can be achieved. A few parameters of the wire coil can to be optimized or balanced between each other, including: coil length, inner diameter, outer diameter, wire gauge, wire resistance, and number of turns.

In the telecommunication optical device application, some considerations should be taken into account:
Inner diameter and number of turns are directly related to the amplitude of magnetic field inside the coil, less inner diameter results in greater magnetic field when the number of turns and driving current are the same. However, both inner and outer diameter are usually limited by the application, too small inner diameter will blocking the light and too large outer diameter will increase final physical size of the device and is not preferable.
When the coil length exceeds a certain limit, more coil length won't increase the magnetic field inside the coil.
The magnetic field produced by the wire coil should be large enough to magnetize and reverse-magnetize the semi-hard magnet core into saturation. (H>2*Hc)
Wire gauge is closely related to driving voltage and driving current. Thinner wires usually result in higher driving voltage and lower driving current, and vise versa.

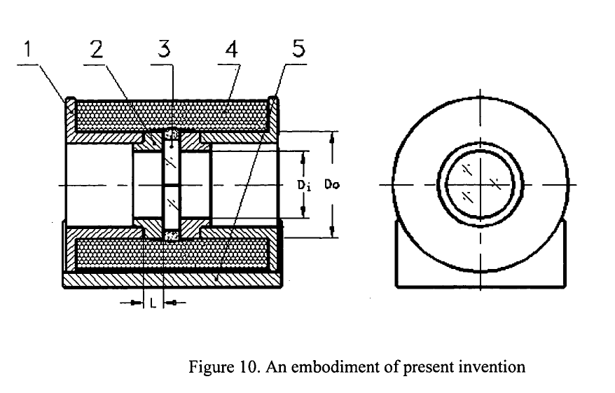

FIG. 10 shows an embodiment of the present invention, including: soft magnetic tubes (1), semi-hard magnet cores (2), magneto-optic crystal (3), wire coil (4), and soft magnetic adaptor (5). The soft magnetic adaptor(5), soft magnetic tube and semi-hard magnet cores (2) form a magnetic conductive close loop. This magnetic conductive loop further reduces the magnetic energy loss and improves the efficiency of energy transferring. The semi-hard magnet cores (2) and the soft magnetic tubes (1) are in a circular symmetric shape to maximize the optical aperture. The length of the semi-hard magnet ring is designed to be 0.2*Do, where Do is the outer diameter of the semi-hard magnet ring, to produce maximal magnetic field at the location of magneto-optic crystal. In general, as long as the light path is not impeded, the cross-section could be in different shapes, for example, square, elliptical or any other closed geometrical shape. The wire coil encompasses the semi-hard magnet rings, soft magnet tubes and the magneto-optic crystal. The wire gauge is designed to be 42 AWG, and the number of turns is 1100, coil resistance is 78 Ohm at 25° C.

When applying a 4V (52 mA) pulse to the wire coil, it can produce over 140 Oersted magnetic field at the location of semi-hard magnet core. Since the coercive force (Hc) of the semi-hard magnet core in this embodiment is about 70 Oersted, it can be easily magnetized or reverse-magnetized into saturation state by the magnetic field of the wire coil. After the driving voltage or current is removed, a magnetic flux density (Br) remains on the semi-hard magnet core.

The semi-hard material used in present invention has very high residual induction (Br>10000 Gauss), and it can generate very high magnetic field in its surrounding region. However, the magnetic field generated by semi-hard magnet is not uniform in space. One major advantage of present invention over prior art inventions is that present invention optimized the semi-hard magnet design so that it can generate maximum magnetic field at the location of magneto-optic crystal.

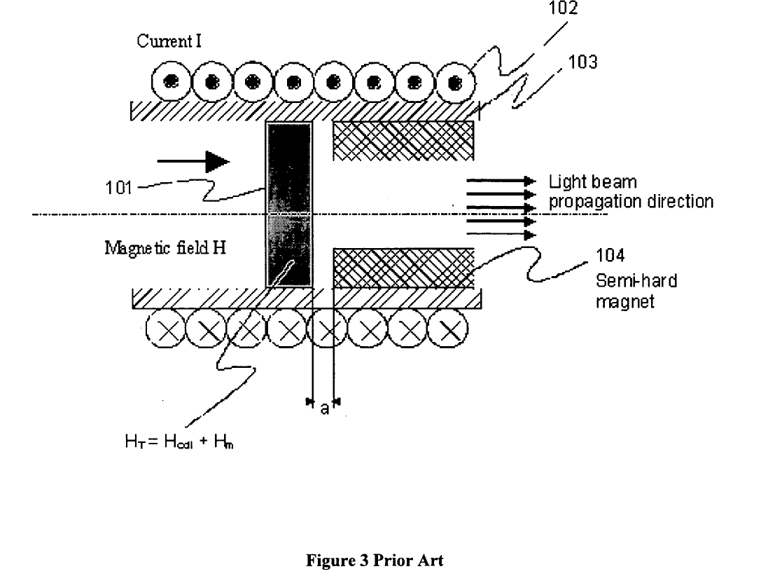

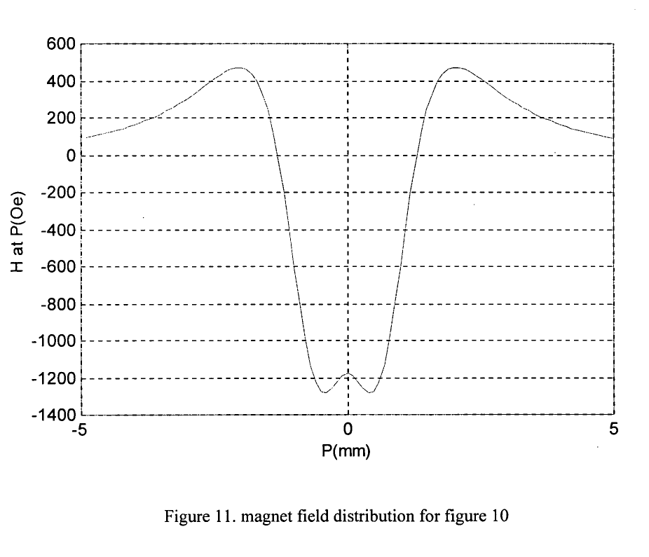

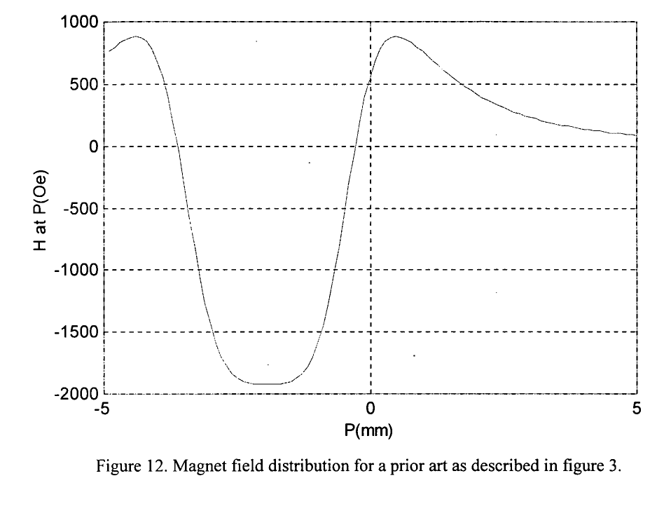

In present invention, the optimization is realized in two different aspects at the same time: 1. The position of the magneto-optic crystal is optimized, so that the magnetic energy is concentrated in the region of the magneto-optic crystal. FIG. 11 shows the magnetic field distribution along the axial direction for FIG. 9. In FIG. 11, P=0 mm is where the magneto-optic crystal is located. FIG. 11 clearly shows that the magneto-optic crystal is located in the region where the magnetic field is most intensive. 2. The length of the semi-hard magnet is optimized so that the semi-hard magnet at this length can produce stronger magnetic field than the magnets in other sizes can produce. To compare with the present invention, FIG. 12 shows the magnetic field distribution of the semi-hard magnet as described in a prior art (FIG. 3). FIG. 12 clearly shows that the magneto-optical crystal is not in the region where the magnetic field is most concentrated.

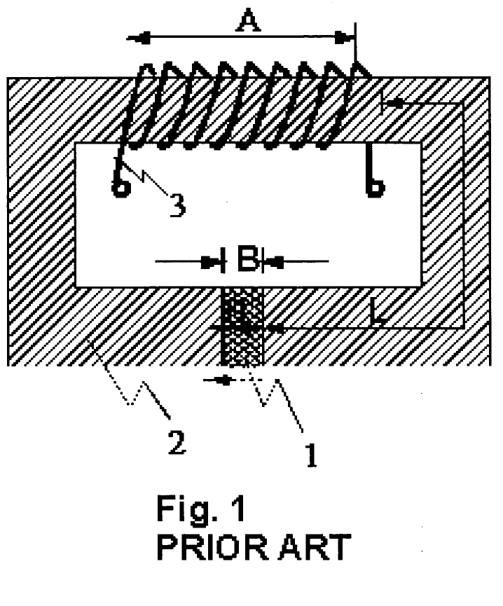

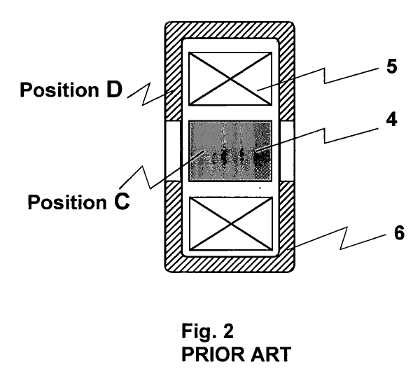

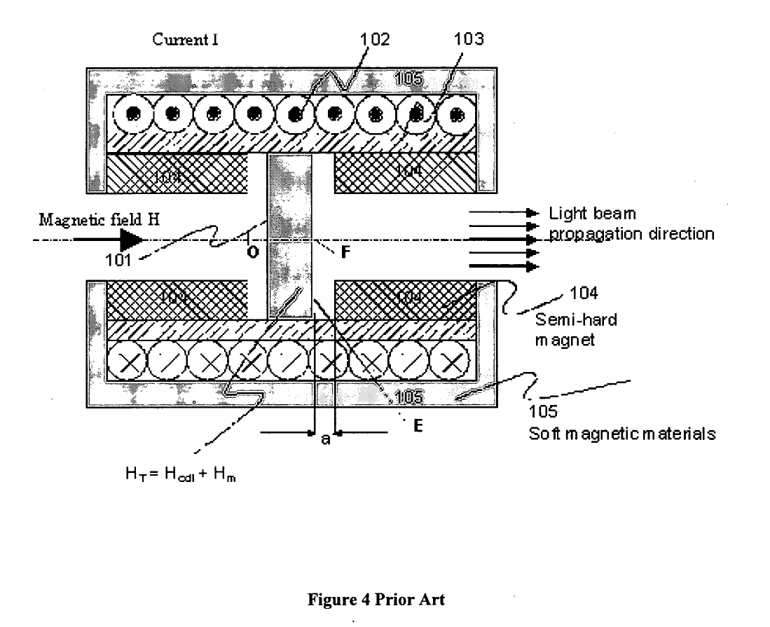

Another advantage of present invention is that the semi-hard magnet is much smaller compared with prior art switchable Faraday rotators (FIG. 1, FIG. 2, FIG. 3, FIG. 4). Hence the semi-hard magnet in present invention is much easier to be magnetized or reverse-magnetized. According to data from the patent disclosures, prior art Faraday rotators in FIG. 1 and FIG. 2 need a driving current of 3 Amps or more to magnetize and latch the semi-hard magnet, while FIG. 3 and FIG. 4 need 100 mA-200 mA (corresponding to 400 Oersted external magnetic field) to magnetize and latch the semi-hard magnet. The present invention as depicted in FIG. 9 needs only 52 mA (corresponding to 140 Oersted external magnetic field) to magnetize and latch the semi-hard magnet.

Having described the invention in detail, those skilled in the art will appreciate that, given the present disclosure, modifications may be made to the invention without departing from the spirit of the inventive concept described herein. Therefore, it is not intended that the scope of the invention be limited to the specific and preferred embodiments illustrated and described.

1. A Faraday rotator device comprising:
a) magneto-optic material; and,
b) two semi-hard magnet cores located in proximity to said magneto-optic material such that the magneto-optic material is affected by the magnetic field of the semi-hard magnet cores.
c) Two soft-magnet tubes located in proximity to said semi-hard magnet cores such that a continuous magnetic flux path from the soft magnet tube to semi-hard magnet core can be built up.
d) a coil encompassing said magneto-optic material, said semi-hard magnet cores, and said soft magnet tubes such that current passing through said coil generates a magnetic field at the location of said magneto-optic material, said soft magnet tubes and semi-hard magnet cores.

2. A device as in claim 1 further comprising a soft magnetic adaptor such that said adaptor, said soft magnet tube, and said semi-hard magnet core form a continuous magnetic flux loop.

3. A device as in claim 1 wherein the coercivity of said semi-hard magnet core is in the range from approximately 10 Oersteds to approximately 100 Oersteds.

4. A device as in claim 1 wherein said semi-hard magnet core is in circular ring shape and said circular ring has the following geometrical characteristics: Di/Do is in the range from 0.6 to 0.7 and L/Do is in the range of 0.2 to 0.4, where Di is the inner diameter of said circular ring, Do is the outer diameter of said circular ring, and L is the length of said circular ring.

5. A device as in claim 1 wherein said semi-hard magnet core is in polygonal ring shape and said polygonal ring has the following geometrical characteristics: the number of sides of said polygonal ring is in the range from 3 to 12, and L/Do is in the range of 0.2 to 0.4, where Do is the outer diameter of said circular ring, and L is the length of said circular ring.

6. A device as in claim 1 wherein the wire gauge of said magnet wire coil is in the range from 38 AWG to 44AWG.

7. A device as in claim 6 wherein the length of said magnet wire coil is in the range from 0.8*Do to 1.5*Do, where Do is the outer diameter of said wire coil.

8. A device as in claim 6 wherein the resistance of said wire coil is in the range from 50 Ohm to 150 Ohm.
